(19) United States
(12) Patent Application Publication
(10) Pub. No.: US 2015/0252955 A1
(43) Pub. Date: Sep. 10, 2015

(54) MULTI-LED LIGHT BULB

(71) Applicant: INTERNATIONAL MARKETING CORPORATION, Turnersville, NJ (US)

(72) Inventor: Andrew A. Boschetto, Sewell, NJ (US)

(21) Appl. No.: 14/642,167

(22) Filed: Mar. 9, 2015

Related U.S. Application Data
(60) Provisional application No. 61/949,766, filed on Mar. 7, 2014.

(51) Int. Cl. F21K 99/00; F21V 23/00; F21V 23/02; F21V 3/04; F21S 4/00

(52) U.S. Cl. CPC F21K 9/1355; F21V 3/0418; F21S 4/008; F21V 3/0436; F21V 23/02; F21V 23/002; F21Y 2103/003

(57) ABSTRACT

An LED light bulb includes a base and a hollow shell. The base has a closed end, an open end and a base body between the two ends. The shell is connected to the open end of the base. The LED light bulb includes at least two LEDs substantially linearly arranged within the shell, and supported by a self-supporting wire set connecting two terminals of an LED to two terminal of the next LED in each strand.

This application claims priority to provisional application Ser. No. 61/949,766 filed on Mar. 7, 2014 in the United States, the disclosure of which is incorporated herein by reference and to which priority is claimed.

### FIELD OF THE INVENTION

The present invention relates to a light bulb. In particular, the present invention relates to a light emitting diode (LED) light bulb that comprises two or more light emitting diodes (LEDs) arrayed in a substantially linear arrangement, with one LED positioned above the other.

### BACKGROUND OF THE INVENTION

Most existing light bulbs are incandescent light bulbs or fluorescent light bulbs. An incandescent light bulb typically comprises a base, a glass shell, a thin filament which is normally a thin tungsten filament within the shell, and an inert gas within the shell. When an electric current passes through the tungsten filament and heats it up to an extremely high temperature (2000° C. to 3000° C.) depending upon the filament type, shape, size, and amount of current passed through, heat radiation occurs and visible light is produced. However, the incandescing process is considered highly inefficient, as over 98% of its energy is emitted as invisible infrared light (or heat) and the luminance cannot further improve. In addition, the typical lifespan of an incandescent bulb is limited to about 1,000 hours.

By comparison, a fluorescent light bulb is filled with gas containing low-pressure mercury vapor and an inert gas, such as argon or xenon. The inner surface of the bulb is coated with a fluorescent (and often slightly phosphorescent) coating made of various blends of metallic and rare-earth phosphor salts. When electricity passes through mercury vapor, the mercury vapor produces ultraviolet light. The ultraviolet light is then absorbed by the phosphorus coating inside the bulb, causing it to glow, or to fluoresce. While the heat generated by fluorescent light is much less than its incandescent counterpart, efficiencies are still lost in generating the ultraviolet light and converting this light into visible light. In addition, mercury is considered detrimental to the health of people and animals. Therefore, if the fluorescent bulb breaks, exposure to the substance can be hazardous. Fluorescent bulbs are typically more expensive than incandescent bulbs, but they have life spans of about 10,000 hours.

A light emitting diode light bulb is another type of light bulb. The LED bulb typically has high durability with no need to worry about the filament breaking as occurs with respect to incandescent bulbs or the noted hazards as can occur with respect to fluorescent bulbs. LED light bulbs have a long life span of approximately 50,000 to 100,000 hours. The LED bulb generates little heat and has little parasitic energy loss, thereby reducing the overall electricity used. This, in turn, increases the possibilities of reducing electricity bills. Since the LED light bulb has so many advantages over the incandescent bulb and the fluorescent bulb, it is considered to be a cost-effective yet high quality replacement for incandescent and fluorescent light bulbs.

There are already some LED bulbs in the market. These LED bulbs either contain one LED in the bulb or at least two LEDs horizontally fixed directly on one printed circuit board (PCB) in the bulb. For the bulb containing only one LED, the light is generally not bright enough for most common uses. The luminance is hard to improve for a bulb containing a single LED. For bulbs having at least two LEDs horizontally fixed on one PCB, the LEDs are in the same horizontal level and the distances that can be brightened by those LEDs are similar because of their attachment to the PCB. When the bulb shell increases in size, the LEDs all have a longer distance to the bulb shell. As the distance from the LED to the shell increases, the brightness becomes weaker and dimmer. Light is governed by an inverse-square law of physics, namely that the intensity/strength of the light from a source is inversely proportional to the square of the distance from the source. Therefore, the use of LED bulbs in the prior art is limited to applications which do not have a high luminance requirement. In order to broaden the use of LED bulbs because of their so many advantages, limited luminance needs improvement.

### SUMMARY OF THE INVENTION

According to an aspect of the invention, there is provided an LED light bulb. The LED light bulb has a base, a hollow shell and at least two LEDs electrically connected to the base. The base has a closed end and an open end and a threaded base body therebetween. The hollow shell is connected to the open end of the base. The LEDs are vertically arranged within the shell, for connection in parallel to a DC power source.

The threaded body may serve as an electrode and the closed end has a contact point serving as another electrode. The two electrodes are connected to a DC power source or may be connected to the input of a power converter, which converts AC power to the DC power to be supplied to the LEDs. The bulb further has an insulating part separating and insulating the two electrodes. The power converter can be arranged inside the hollow base or located outside of the bulb. In the preferred embodiment, the bulb is directly connected to a DC power source, such as a battery.

The shell may be made of transparent plastic, transparent glass or similar materials.

The power converter may include a filter circuit, a bridge rectifier circuit, and a resistor. The bridge rectifier circuit is connected to the electrodes via the filter circuit, and the output of the bridge rectifier circuit is connected to LEDs via the resistor. The LEDs can be connected in parallel or in series, although it is preferred that they be connected in parallel. The LEDs are vertically stacked within the shell, one above the other.

The LED bulb according to the present invention, due to the vertically stacked arrangement, does not increase the distance from the LEDs to the top of the bulb shell when the bulb shell is bigger and higher, so luminance or brightness can be enhanced by varying the number of LEDs in the bulb. In addition, the LED bulb according to the present invention consumes less energy than traditional incandescent or fluorescent bulbs and has a longer life (about 50,000 to 100,000 hours). It is also compatible with the bases of the existing light bulbs. Therefore, replacing a traditional bulb with one according the present invention is convenient and practical.

In accordance with another aspect of the present invention, there is provided the bulb of the present invention, further comprising a wire set support for maintaining at least two LEDs in a substantially linear, vertically arranged position.

In accordance with another aspect of the present invention, there is provided the bulb of the present invention, wherein the LEDs are connected in parallel.

### BRIEF DESCRIPTION OF THE DRAWINGS

The embodiments of the invention will be better understood by the detailed description thereof, with reference to the accompanying drawings, wherein like reference numerals refer to the like elements throughout, in which:

FIG. 1 is a perspective view of an LED bulb according to the prior art.

FIG. 2 is a perspective view of another LED bulb according to the prior art.

FIG. 3 is a perspective view of an LED bulb in accordance with one embodiment of the present invention.

FIG. 4 is a side view of an LED bulb in accordance of the present invention in cross section.

FIG. 5 is an alternate side view of the LED bulb shown in FIGS. 3 and 4.

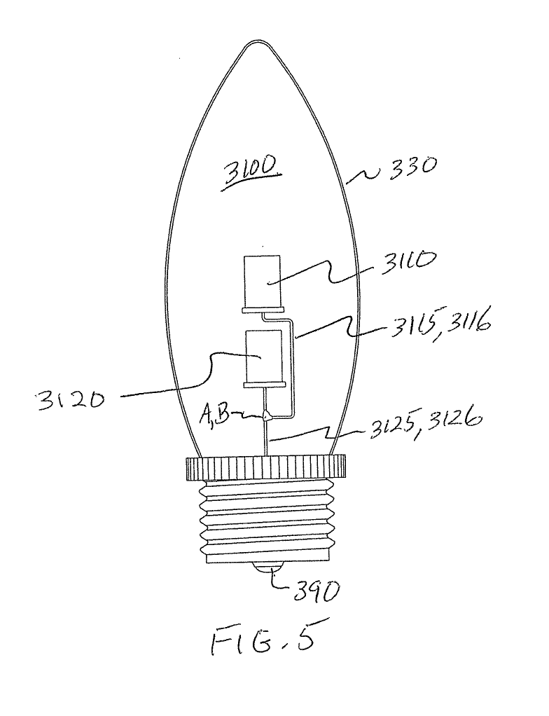

FIG. 6 illustrates a power converter circuitry for optional use with the present invention.

FIG. 7 illustrates a steady-burn circuit for a white double-LED bulb arrangement according to the present invention.

FIG. 8 illustrates a sensor circuit for a white double-LED bulb arrangement according to the present invention.

FIG. 9 illustrates a steady-burn circuit for a gold double-LED bulb arrangement according to the present invention.

FIG. 10 illustrates a flicker circuitry for a gold double-LED bulb arrangement according to the present invention.

### DETAILED DESCRIPTION OF THE INVENTION

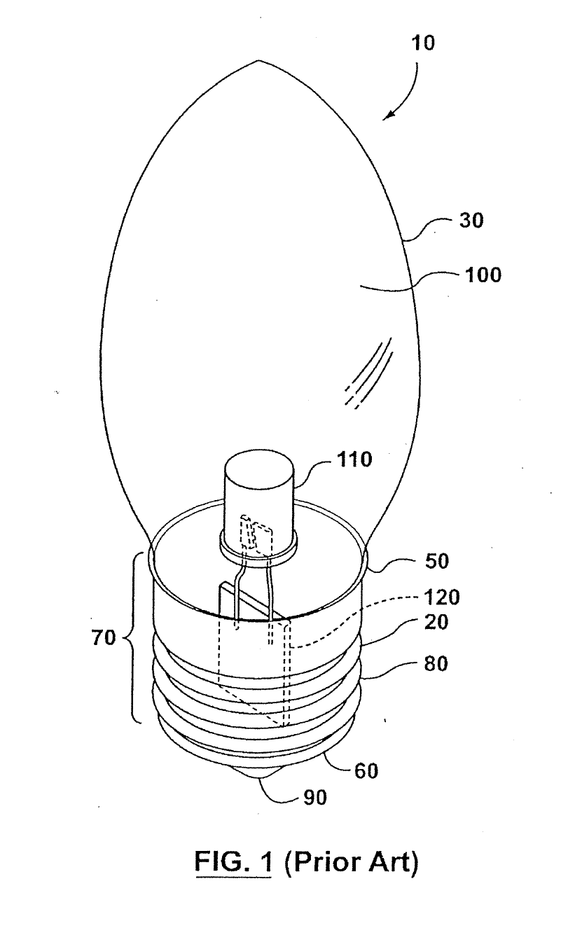

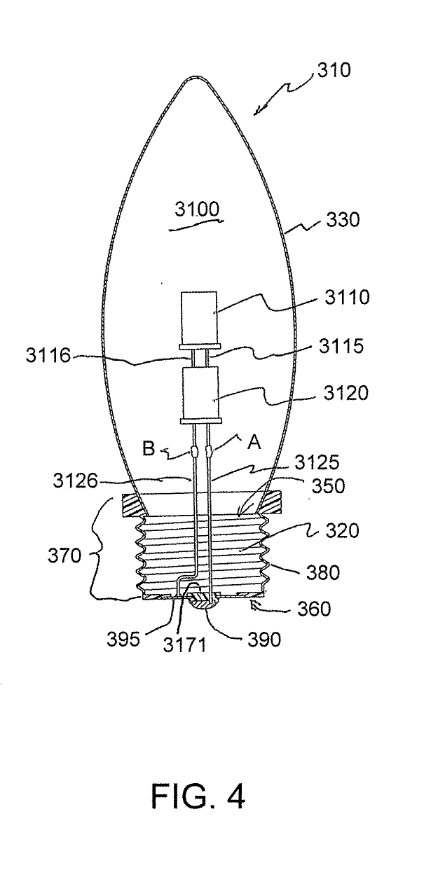

FIG. 1 illustrates a LED bulb according to the prior art. The LED bulb, generally shown as 10, comprises a hollow base 20 and a hollow shell or sometimes referred to as an envelope 30. For the instant application, the entire article illustrated, for example in FIG. 1, is called a bulb. The LED inside the bulb, for example LED 110, is called a LED. The base 20 has an open end 50, a closed end 60 and a base body 70 between the ends 50 and 60. The base body 70 has external threading 80 so as to match internal threading in a conventional bulb holder (not shown) for installment. The base body 70 serves as an electrode. In the central part of the closed end 60 is located a contact point or portion, serving as another electrode 90, and an insulating portion (3171 in FIG. 4 which illustrates an embodiment of the invention) separates and insulates the two parts 70 and 90. When the LED bulb 10 is installed in a bulb holder, such as in a desk lamp, parts 70 and 90, acting as electrodes, are connected to the electrical contact points in the bulb holder. The electrical contact points in the bulb holder are typically further connected to a plug or switch in order to provide electricity to the bulb, thereby causing the LED to light up.

The shell or envelope 30 is connected to open end 50 of base 20 and thus forms an enclosed compartment 100 together with the closed end 60 of the base 20. Within the compartment 100, the bulb 10 comprises at least one an LED 110. Corresponding to the sleeve portion 70 in the compartment 100 may be located a power converter 120, which converts AC to DC and supplies energy to at least one LED contained within the bulb 10. Alternatively, the power converter can be located outside of the LED bulb and supply DC power directly to multiple LED bulbs each constructed similarly to the prior art bulb 10 illustrated in FIG. 1. Alternatively, the bulb 10 may be designed to receive DC power from a DC source such as at least one battery.

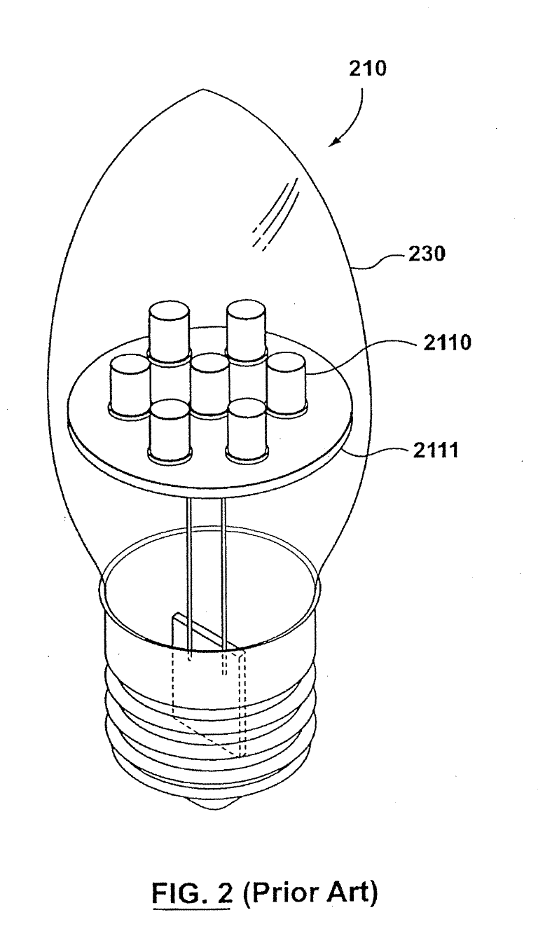

FIG. 2 illustrates another prior art LED bulb 210. It is similar to the LED bulb 10 in FIG. 1, and the main difference is that it comprises more than one LED, such as LEDs 2110, more specifically seven LEDs, within the shell 230. The seven LEDs in the prior art bulb 210 of FIG. 2 are horizontally fixed on a printed circuit board (PCB) 2111, with presumably a goal to enhance the luminance of the bulb. However, the distance that can be brightened is not much more than a bulb with a single LED, because all of the LEDs are grouped together in a common place.

As light waves move away from the light source, the light waves spread out over a distance and quickly diminish in intensity. It is known that there is light intensity decay over distance with light intensity decreasing quickly as the distance from the light source increases. The intensity of light is the power per unit of area. Area increases as the square of the distance, and therefore light decreases as the inverse square of the distance. Light intensity follows an inverse-square law. Therefore if all the LEDs are in the same or substantially the same horizontal plane, the brightness or light intensity of the bulb will not increase significantly between the prior art bulb in FIG. 1 and the prior art bulb illustrated in FIG. 2 despite the additional LEDs present in FIG. 2.

Furthermore, with more LEDs on a PCB, the bulb shell 230 must be big enough to accommodate them. Since a bulb (for example bulb 10 or bulb 210) typically has a smaller diameter than its height (as illustrated), then a horizontal distribution of LEDs on a PCB will be limited by the size of the bulb shell.

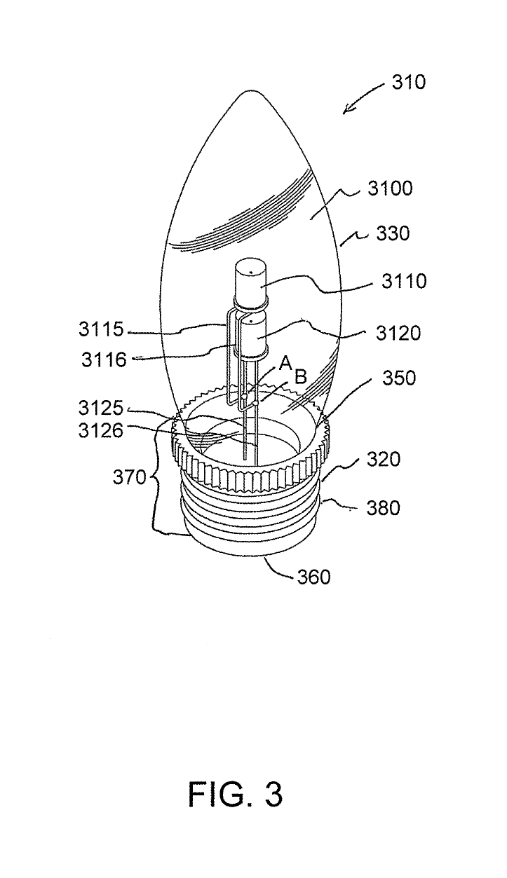

FIG. 3 is an illustration of an LED bulb in accordance with one embodiment of the present invention. The LED bulb 310 comprises a hollow base 320 with an open end 350, a closed end 360 and a base body 370 therebetween. A hollow shell 330 is connected to the open end 350 of the base 320, and a space 3100 is formed by the shell 330 and the base 320. In an exemplary embodiment, hollow shell 330 can be manufactured using clear PS plastic material. The base body 370 has external threading 380 to be installed in an internally threaded conventional bulb holder. The closed end 360 has a contact portion or point 390 serving as one electrode and a flat ring 395 serves as a second contact (see FIG. 4). An insulating part (3171 in FIG. 4), made of rubber or other insulating material, separates and insulates the two parts 390 and 395. In the base body portion 370 of the compartment 3100 a power converter (not shown) may be located for converting AC to DC and supplying DC power to the LEDs.

Unlike the prior art bulb in FIG. 1, the particular example illustrated by bulb 310 comprises at least two LEDs 3110, 3120 contained within the compartment 3100 so as to increase the luminance created by the bulb. In an exemplary embodiment, each LED 3110, 3120 is a 5.0×6.8 mm flange LED including a reflective cup where the reflective cup allows the light emitted by each LED 3110, 3120 to be directed at a power angle of approximately 120°. Each LED 3110, 3120 can be manufactured using InGaN/Sapphire material such that the emitting color is yellow-gold, cool white, warm white, etc. The maximum power dissipation of each LED 3110, 3120 is 110 mV, the maximum forward current (DC) is 30 mA, the maximum peak forward current is 180 mA, the maximum reverse voltage is 5 V, the maximum electrostatic discharge is 150 V, the maximum operation temperature is in the range of approximately −25 to 80° C., and the maximum storage temperature is in the range of −30 to 80° C. Each LED 3110, 3120 can be driven at a pulse width of less than or equal to 0.1 msec and a duty cycle of less than or equal to 1/10. The electrical and optical characteristics of each LED 3110, 3120 include an emitting color of white, a forward voltage in the range of approximately 3.0-3.8 V and typically 3.4 V, a recommended forward current of approximately 10-20 mA and typically 15 mA, a maximum reverse current voltage of approximately 10 V, a color temperature of approximately 3500° K, a luminous intensity of approximately 500 mcd, and a 50% power angle of 120 degrees. In an exemplary embodiment, the tolerance of the luminous intensity is approximately ±15%, a tolerance of dominant wavelength of approximately ±1.0 nm, and a tolerance of forward voltage of approximately ±0.05 V.

The LEDs 3110, 3120 are vertically stacked such that for all but the last LED in each strand, the envelope top end of any given LED of a strand substantially faces the base of an adjacent LED in the strand and connected in parallel with each other and also connected in series with the power converter. Although FIG. 3 illustrates two LEDs in the bulb 310, the number of LEDs contained in the bulb 310 can vary from two to any number that can be arrayed within compartment 3100 depending upon the dimensions of the bulb shell 330. For example, three, four, or more LEDs can be stacked vertically within the bulb shell 330. Preferred embodiments comprise at least 2 LEDs.

As shown in FIG. 3, the top LED 3110 comprises a pair of wires 3115, 3116 that serve as positive and negative electric leads and as a support structure for the LED 3110. For example, wire 3115 is a positive electric lead wire and wire 3116 is a negative electric lead wire. Likewise, the lower LED 3120 includes a pair of wires 3125, 3126 that serve as positive and negative electric lead wires, respectively. In addition, wires 3125, 3126 provide a support structure for the LED 3120. As illustrated in FIG. 3, positive electric lead wire 3115 is coupled to positive electric lead wire 3125 and negative electric lead wire 3116 is coupled to negative electric lead wire 3126. For example, wire 3115 is soldered to wire 3125 at solder point A and wire 3116 soldered to wire 3126 at solder point B. As shown in FIG. 3, the pair of lead wires 3115, 3116 serves as a self-supporting wire structure for the top LED 3110. At the same time, the self-supporting wire structure provides a parallel electric connection between the LEDs 3110 and 3120. Of course, the embodiment of FIG. 3 shows only two LEDS 3110, 3120; however, the present invention may comprise more than two LEDS with the additional LEDS having similar positive and negative wires that serve as a self-supporting wire structure for the additional LED(s). Due to the parallel electric connection between LED 3110 and 3120, when power is supplied to the bulb 3100 both LEDs 3110, 3120 are illuminated at the same time.

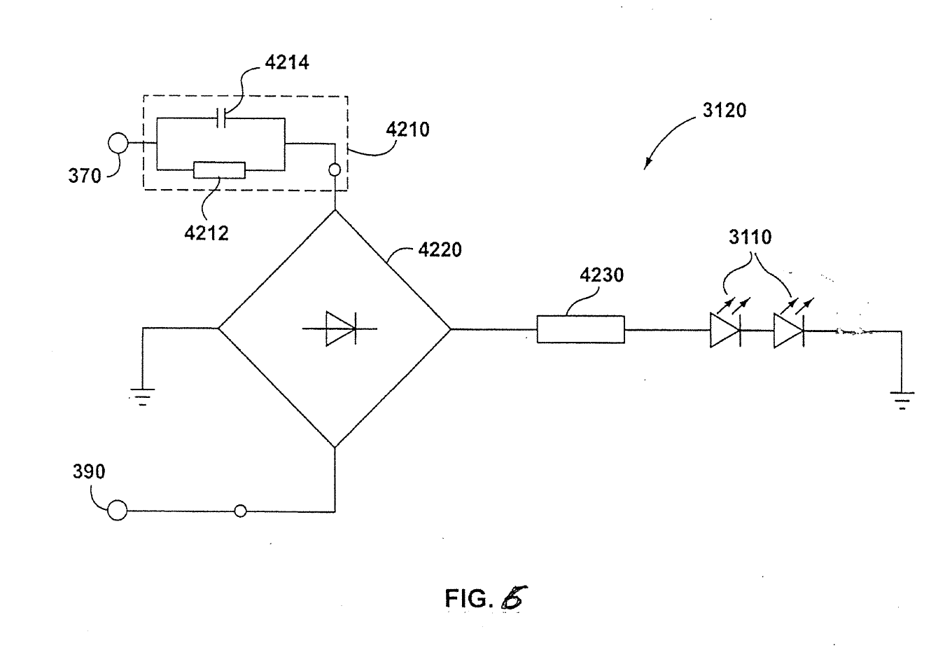

Referring to FIG. 6, the power converter 3120 comprises a filter circuit 4210, and a bridge rectifier circuit 4220, and a resistor 4230. The filter circuit 4210 further comprises a resistor 4212 and a capacitor 4214, connected in parallel. The bridge rectifier circuit 4220 is connected to the electrodes (power supply) via the filter circuit 4210, and the output of the bridge rectifier circuit 4220 is connected to LEDs 3110 via the resistor 4230. Thus the alternating current flowing to the LEDs 3110 from the power supply connected to the plug of the bulb holder is converted to direct current needed by the LEDs 3110, 3120, so as to cause the LEDs to emit light. In an exemplary embodiment, the power supply can include 2×1.5 V batteries (e.g., AA batteries). However, one of ordinary skill in the art would recognize that other known power sources could be used.

The power adaptor can also be located outside of the LED bulb and can be adapted to supply DC power directly to one or multiple LED bulbs. Furthermore, those skilled in the art will understand that other kinds of power converters and/or filter circuits can also be used. The base can be of bi-pin type instead of the screw base illustrated herein, or any other type of lamp base with inner space no less than the E-12 type lamp base. The vertical arrangement of the LEDs is generally linear and can extend substantially vertical or can be pointed in a particular direction. In a substantially vertical embodiment, the arrangement need not be precisely vertical, indeed the LEDs may be offset from each other by a few degrees, or the whole strand of stacked LEDs may be offset from the vertical position by a few degrees. In either case, a person skilled in the art will understand that such variances are acceptable in the operation of the LED bulb of the present invention.

FIG. 4 is a side view of a LED bulb in accordance of the present invention in cross section. The LED bulb 310 comprises a hollow base 320 with an open end 350, a closed end 360 and a base body 370 therebetween, a hollow shell 330 connected to the open end 350 of the base 320, and a compartment 3100 formed by the shell 330 and the base 320. The base body 370 has external threading 380 to be installed in an internally threaded bulb holder. The closed end 360 has a contact portion or point 390 serving as another electrode and a metallic ring 395 serves as a second contact portion. An insulating part 3171, made of rubber or other insulating material, separates and insulates the two parts 390 and 395. In the base body portion 370 of the compartment 3100, a power converter (not shown) may be located for converting AC to DC and supplying DC power to the LEDs.

The particular example illustrated by bulb 310 in FIG. 4 comprises two LEDs 3110, 3120 contained within the compartment 3100 so as to increase the luminance created by the bulb 310. The LEDs 3110, 3120 are stacked in a strand such that for all but the last LED in each strand, the envelope top end of any given LED of a strand substantially faces the base of an adjacent LED in the strand and is connected in parallel through wires 3115 and 3116. They may also be connected to the power converter in parallel or in series. The bulb 310 in FIG. 4 has a traditionally narrowed tip end consistent with decorative bulbs common in bulbs for the holiday seasons. Although FIG. 4 illustrates two LEDs in the bulb, the number of LEDs contained in the bulb can vary from two to any number that can be linearly contained within compartment 3100 and in this embodiment the strand of two LEDs is arranged in a substantially vertically orientation.

A globe bulb may be used, for example in Halloween lights which may be shaped like a pumpkin. Other arrangements of single substantially linear strands and multiple substantially linear strands would be known to a person skilled in the art and would be suitable for bulbs of varying sizes and shapes.

Because the voltage drop across each LED is small, due to the difficulties of constructing a circuit with LEDs in parallel, the number of LEDs that can be connected in parallel is limited by the amount of the voltage drop.

By stacking LEDs in vertical, substantially linear strands arranged such that for all but the last LED in each strand, the envelope top end of any given LED of a strand substantially faces the base of an adjacent LED in the strand, an LED bulb of the present invention is able to distribute light evenly within the entirety of the bulb compared to the prior art including where the bulb is pointed such as in a Christmas tree bulb or the bulbs of outdoor lights which are strung at Christmas. This is possible because in accordance with an advantage of the present invention the distance from any location in a bulb to the closest LED to that location varies less in the bulb of the present invention than in a bulb of the prior art. For example, the distance between the top of the bulb shell and an LED fixed to the PCB in the prior art shown in FIG. 2 is much greater than the distance from the top of the bulb shell to the top-most LED in the stacked arrangement shown in FIG. 3. In this example, light from the top LED in the stack does not have to travel as far in the present invention to reach the top of the bulb shell, and therefore allows that location to appear brighter than it does in the prior art. In practice, this means that an LED bulb of the present invention using the same number of LEDs as a prior art bulb from FIG. 2 will appear brighter, especially when viewed from the side or from a long distance away.

The LED bulb of the present invention has other advantages over the prior art. It is possible to create larger bulbs while maintaining even brightness distribution by using multiple linear stacks oriented in substantially vertical, or oriented diagonally of LEDs arranged side-by-side. In this way, light can be distributed more evenly throughout the bulb, regardless of the size of the bulb, simply by adding more stacks of LEDs beside one another in the bulb.

It was also determined that the cost of manufacturing a LED bulb of the present invention that uses 2 to 4 LEDs is lower than the cost of manufacturing a LED bulb of the prior art horizontally arrayed LEDs using the same number of LEDs.

Note that it is possible to create a LED bulb of the prior art using multiple PCBs, each having multiple LEDs, where each PCB is positioned parallel to the other PCBs, both above and below the single PCB shown in FIG. 2. Depending on the arrangements of the LEDs on the PCBs, it is possible to increase the brightness of the LED bulb of the prior art in this way. However, in order to achieve brightness that is similar to the brightness of the LED bulb of the present invention, such an arrayed PCB design would require more LEDs and have increased manufacturing cost compared to the LED bulb of the present invention.

The LED bulb can be used in various applications, such as household, work plant, show window, store, street display, exterior decorations. The LED bulbs of the present invention are applicable in many setting requiring light and can provide enhanced luminescence and brightness over prior art LED bulbs at a lower cost of manufacturing as described herein. The luminance of the LED bulb can be adjusted by including various LEDs in the bulb.

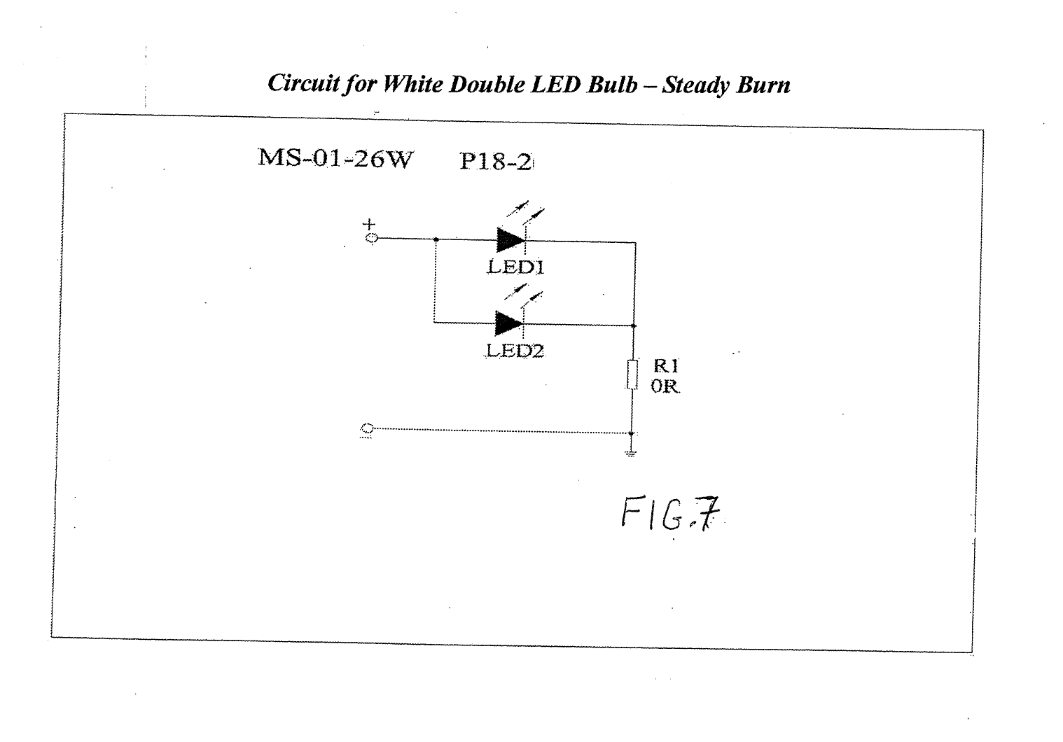

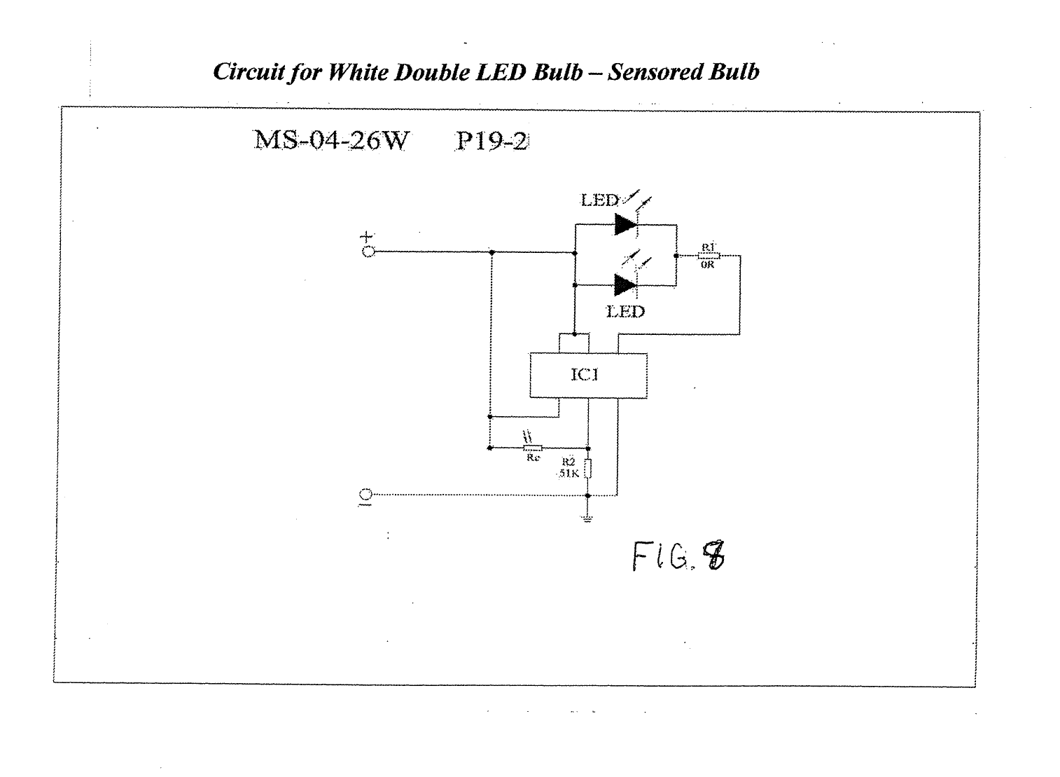

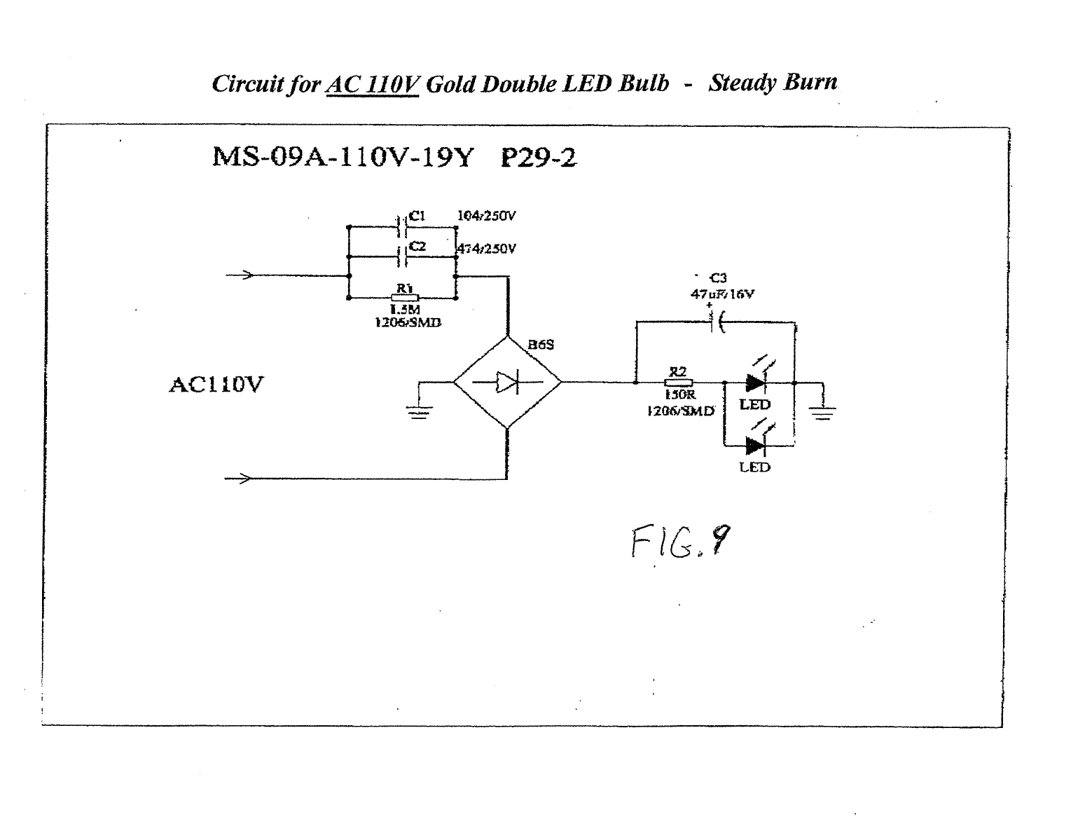

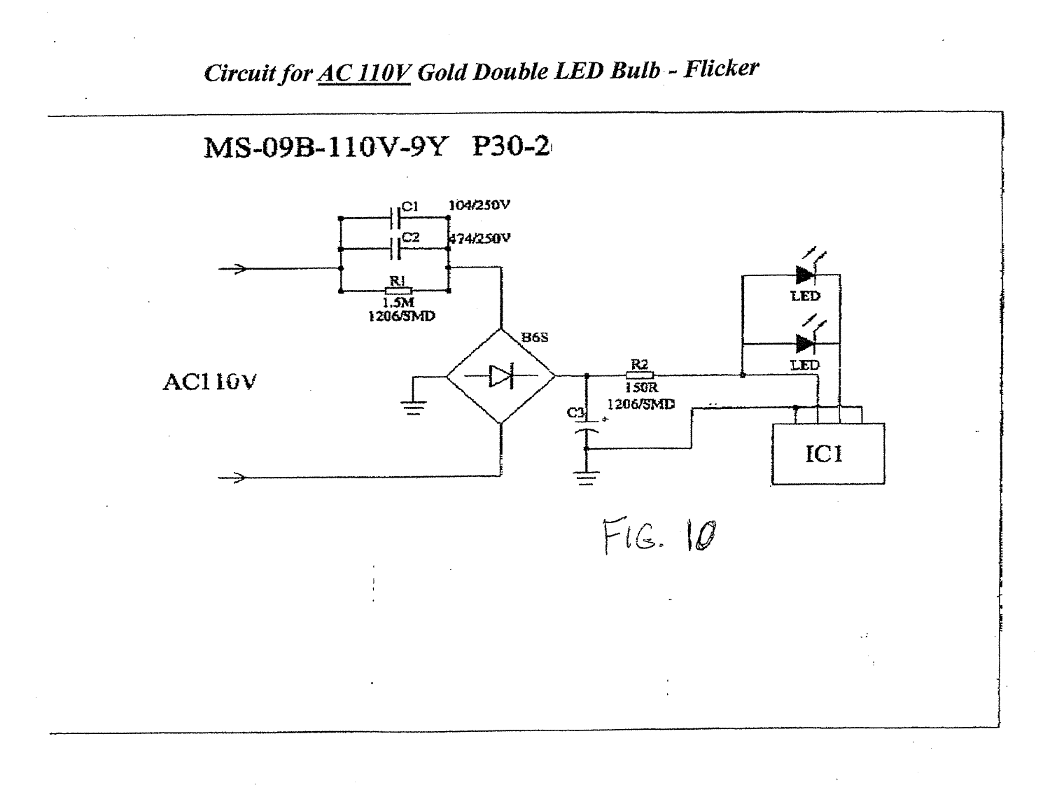

While this invention has been illustrated and described in connection with only certain embodiments thereof, various changes, modifications and amendments can occur to those skilled in the art without departing from the spirit and the scope of the invention as defined in the appended claims. For example, FIG. 7 illustrates a steady-burn circuit for a white double-LED bulb arrangement according to the present invention. The steady-burn circuit illustrated in FIG. 7 includes a resistor R10R in series with the output of LED1 and LED2. FIG. 8 illustrates a sensor circuit for a white double-LED bulb arrangement according to the present invention. The sensor circuit illustrated in FIG. 8 includes a light sensing device Rc coupled to the LEDs such that the light output of the LEDs is based on light levels detected at light sensing device Rc. The sensor circuit illustrated in FIG. 8 further includes an integrated circuit IC1 that influences the light emitted from the LEDs to create a flickering effect. FIG. 9 illustrates a steady-burn circuit for a gold double-LED bulb arrangement according to the present invention. The steady-burn circuit for the gold double-LED bulb arrangement includes a power converter having two capacitors C1, C2 coupled in parallel with resistor R1, bridge rectifier circuit B6S, a polarized capacitor C3, and a resistor R2 where the capacitor C3 in combination with resistor R2 modifies the current applied to the LEDs such that a gold or yellow-gold light is emitted from the LEDs. FIG. 10 illustrates a flicker circuit for a gold double-LED bulb arrangement according to the present invention. The flicker circuit for the gold double-LED bulb arrangement includes a power converter having two capacitors C1, C2 coupled in parallel with resistor R1, bridge rectifier circuit B6S, a polarized capacitor C3, a resistor R2, and an integrated circuit IC1. The capacitor C3 in combination with resistor R2 modifies the current applied to the LEDs such that a gold or yellow-gold light is emitted from the LEDs and the integrated circuit IC1 influences the light emitted from the LEDs to create a flickering effect. These different circuitries are provided by way of example and are not intended to limit the scope of the present invention as defined by the appended claims.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

1. A bulb, comprising:
a base, said base comprising a closed end, an open end and a base body therebetween, wherein said sleeve serves as an electrode and said closed end comprises a contact point serving as another electrode;
a hollow shell connected to said open end of said base;
a strand of at least two LEDs, each LED comprising a base having first and second electrical terminals and an envelope extending from said base to an envelope top end distal from said base, said LEDs joined together and arranged within the shell such that for all LEDs, but for the last LED, in each strand, said envelope top end of any given LED in said strand substantially faces said base of an adjacent LED in said strand, and
a self-supporting wire set connecting first and second terminals of a first LED in said strand to respective first and seconds terminals of a second LED in said strand, such that said first LED is coupled in parallel with said second LED and said self-supporting wire set acts to support said strand.

2. The bulb according to claim 1, wherein the shell is made of translucent or transparent plastic.

3. The bulb according to claim 1, wherein the shell is made of translucent or transparent glass.

4. The bulb according to claim 1, wherein the LEDs have a radiation directivity of 120°.

5. The bulb according to claim 1, wherein a positive terminal of said first LED is soldered to a positive terminal of said second LED.

6. The bulb according to claim 1, including a hollow plastic stem adapted to contain the at least two LEDs.

7. The bulb according to claim 6, wherein the LEDs are oriented in a substantially vertical direction in relation to said bulb.

8. The bulb according to claim 1, wherein the base of the bulb is hollow, and, within the hollow base, the bulb further comprises a power converter for converting AC power to DC power to be supplied to the LEDs.

9. The bulb of claim 8, wherein both the two electrodes are connected to the input of the power converter; and the bulb further comprises an insulating part separating and insulating the two electrodes.

10. The bulb according to claim 9, wherein the power converter includes a filter circuit, a bridge rectifier circuit, and a resistor; the bridge rectifier circuit is connected to the electrodes via the filter circuit, and the output of the bridge rectifier circuit is connected to LEDs via the resistor.

11. The bulb according to claim 10, wherein the sleeve of the base includes external threading.

12. A LED bulb, the bulb comprising:
a base, said base further comprising a closed end, an open end and a base body therebetween, wherein said base body serves as an electrode and said closed end comprises a contact point serving as another electrode;
a hollow shell connected to the open end of the base;
at least one strand of LEDs wherein each strand of LEDs comprises at least two LEDs, each LED comprising a base having electrical terminals and an envelope extending from said base to an envelope top end distal from said base, said LEDs joined together and arranged within the shell such that for all LEDs, but for a last LED, in each strand, said envelope top end of any given LED in said strand substantially faces said base of an adjacent LED in said strand;
a self-supporting wire set connecting a first set of terminals of a first LED in each strand to a second set of terminal of a second LED in each strand, such that said first LED and said second LED are connected in parallel and said self-supporting wire set acts to support said strand, and wherein said bulb is adapted for connection to a power source.

13. The bulb according to claim 12 wherein said strands of LEDs are joined to form an array whereby each strand points in a different direction within said hollow shell.

14. The bulb according to claim 12 wherein said strands are each oriented in a substantially vertical orientation within said hollow shell.

15. The bulb according to claim 12 wherein the LEDs have a radiation directivity of 120°.
